(19) United States
(12) Patent Application Publication
(10) Pub. No.: US 2007/0040503 A1
(43) Pub. Date: Feb. 22, 2007

(54) Microstructure non-thermal visible light source

(76) Inventors: Charles Chase, Palmdale, CA (US); Laurence H. Bloxham, Acton, CA (US)

Correspondence Address: DENNIS W. BEECH (LAW OFFICE OF DENNIS W. BEECH), P.O. BOX 519, MURRIETA, CA, 92564-0519, US

(21) Appl. No.: 11/504,128

(22) Filed: Aug. 14, 2006

Related U.S. Application Data
(60) Provisional application No. 60/709,354, filed on Aug. 18, 2005.

(51) Int. Cl. H01J 61/00; H01J 61/28

(52) U.S. Cl. 313/567

(57) ABSTRACT

The microstructure non-thermal visible light source may emit visible light. A microstructure element may be filled with a gas and may be disposed in a light transparent dielectric binder positioned between two spaced apart electrical conductors. An electrical source may be in electrical communication with the electrical conductors for the electrical source to transmit a signal to the electrical conductors to excite the gas to cause an electron in a plurality of gas molecules to transition to higher energy states. The higher energy states may be metastable and the higher energy states may decay with the emission of a photon at selected wavelengths.

### CROSS REFERENCE TO RELATED APPLICATIONS

This application claims the benefit of Provisional Application No. 60/709,354, filed on Aug. 18, 2005

### BACKGROUND OF THE INVENTION

This invention relates to devices that produce visible light for illumination, display and the like. The new device may have microstructure elements filled with a gas that may be excited by an electric field to produce a desired color of light or a spectrum of white light.

Various light sources have been disclosed that may be formed of small devices, such as, solid state semiconductor devices, ceramic and polymer material devices similar to LED's, and electrodes in a gas enclosure. Some of these devices are non-thermal light emitting sources such as a solid state semiconductor device or a microdischarge device having electrodes imbedded in a gas enclosure while others may have thermal emission light characteristics such as a miniature incandescent light bulb. The various light source devices may produce poor spectral quality illumination as for example semiconductor devices may have good spectral control, but lack high intensity. Also, fabrication costs may be relatively high as for example that of semiconductor devices.

### SUMMARY OF THE INVENTION

The present invention is directed to devices that may emit visible light. A microstructure element may be filled with a gas and may be disposed in a light transparent dielectric binder positioned between two spaced apart electrical conductors. An electrical source may be in electrical communication with the electrical conductors for the electrical source to transmit a signal to the electrical conductors to excite the gas to cause an electron in a plurality of gas molecules to transition to higher energy states. The higher energy states may be metastable and the higher energy states may decay with the emission of a photon at selected wavelengths.

These and other features, aspects and advantages of the present invention will become better understood with reference to the following drawings, description and claims.

### BRIEF DESCRIPTION OF THE DRAWINGS

FIG. 1 illustrates a side view of a microstructure visible light source with multiple microstructure elements according to an embodiment of the invention;

FIG. 2 illustrates a top view of a microstructure visible light source according to an embodiment of the invention;

FIG. 3 illustrates a side view of a microstructure visible light source member of an array structure according to an embodiment of the invention;

FIG. 4 illustrates a side view of a microstructure visible light source member of an array structure according to an embodiment of the invention;

FIG. 5 illustrates a side view of a microstructure visible light source member of an array structure according to an embodiment of the invention;

FIG. 6 illustrates a top view of a microstructure visible light source array according to an embodiment of the invention;

FIG. 7 illustrates a top view of a microstructure visible light source array according to an embodiment of the invention;

FIG. 8 illustrates a top view of a microstructure visible light source array according to an embodiment of the invention;

FIG. 9 illustrates a perspective view of a relatively thin, flexible curved microstructure visible light source according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

Microstructure elements may be filled with a gas that may be excited by an electric field. The electrons in the gas molecules may transition to higher energy states that have been designed to be metastable, that is, have a short lifetime. The molecular energy states decay with the emission of photons at the engineered wavelengths. The specific excited states and emitted wavelengths may be determined by the strength and modulation of the applied electric field, the size and wall composition of a microstructure element and the gas molecules in the microstructure element. These parameters may be controlled to optimize efficiency and tune spectral content and spatial geometry. Each microstructure may be an individual high intensity non-thermal emitter. The color of the emissions may be determined by the excited gas and the specific decay process permitted by the geometry, by electric field and by the material in the binder. The patterns of the emitted light may be controlled by the geometry of the electrodes that are the source of the excitation fields, and the characteristics of the supplied electrical power.

The microstructure visible light source may emit visible wavelengths directly. No intermediate process may be needed between the excitation of the gases and the emission of the desired wavelengths. This is an energy efficient process.

Referring to FIGS. 1 and 2, a microstructure visible light source 10 may have multiple microstructure elements 12 embedded in a dielectric binder 14 that is sandwiched or disposed between a base conductor 16 and a top conductor 18. There may be an electrical source 20 connected to the base conductor 16 and top conductor 18 to produce an electric field between the conductors 16, 18. The microstructure elements 12 may be gas filled containers that may be a glass, or other suitable material, microsphere of approximately 20 to 100 microns in diameter that may be filled with nitrogen gas to produce a wide spectral content white light.

The size of the microstructure elements 12, that are mesoscopic, may determine the light spectrum and efficiency. The gas in each microstructure element 12 may be nitrogen, argon or other gas to produce a desired color, or may be a mixture of multiple gases to produce the spectral content of emitted light. The microstructure elements 12 may be made of glass or other material that is generally transparent. The microstructure elements 12 may also be coated with material such as phosphorous to produce a particular color effect. While spherical shapes for the microsphere elements 12 are illustrated, other shapes, such as, cylinders, cones, irregular shapes and other geometric shapes may be used. The microsphere elements may be positioned randomly or orderly in the dielectric binder 14.

The dielectric binder 14 may have a high dielectric breakdown strength and be transparent in the visual spectrum. The dielectric material may be flexible or stiff and may be selected depending on the particular application. Phosphorous may be added to the dielectric binder 14 to produce a particular color effect.

The base conductor 16 may range from flexible to rigid and may be formed of metal, metal coated with Kapton, circuit board materials, or titanium sheet material. The base conductor 16 may be relatively thin or thick depending on the application, for example, less than 1 mil to greater than 10 mils, and be a good electrical conductor.

The top conductor 18 may be electrically conductive and visually transparent to pass emitted light from the microstructure elements 12. The top conductor 18 may be formed of a substrate material 22 and a conductive coating 24. The materials may be plastic, glass or other suitable transparent material coated with indium tin oxide that may have approximately 10 to 15 ohms per square inch surface resistance. The resistance value may be a trade between efficiency, cost durability, and spectral intensity and visual content. The top conductor 18 may range from flexible to rigid in structure.

The electric source 20 may produce an electric field between the conductors 16, 18 that may excite the gas in the microstructure elements 12. Once the gas molecules are in the desired excited state, when they decay, light may be emitted. The electrical source 20 may be a standard power source converted or transformed to produce the desired electrical field between the conductors 16, 18. The voltage, pulse width, and pulse repetition frequency may be adjusted to establish spectral content, efficiency and durability.

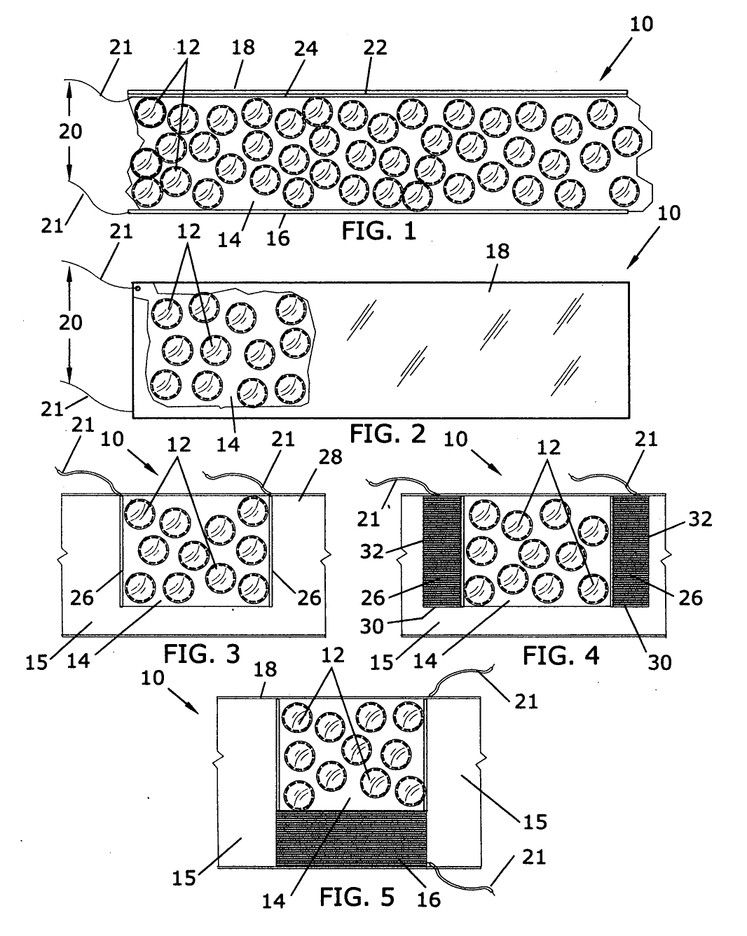

Referring to FIGS. 3 through 5, other arrangements of the conductors 16, 18 of the microstructure visible light source 10 may be used. For example, the conductors 26 may be located on opposite sides of a dielectric binder 14 having microstructure elements 12 to excite the gas molecules. The emitted light may still be directed to exit the top 28 of the microstructure visible light source 10. The conductors 26 may also have a geometry from a relatively thin form to a broader structure as illustrated in FIG. 4. This may be useful in a fabrication process where the microstructure elements 12 may be formed in an array or in a broad dielectric substrate 15 material. A dielectric substrate 15 may have channels 30 or grooves formed therein in which the dielectric binder 14 with microstructure elements 12 may be disposed and the conductors 26 may be formed by disposing silver, copper, aluminum or other suitable conductive metals between the sides 32 and the dielectric binder 14. The conductors 16, 18 or 26 may have electrical conduits 21 connected at a surface or electrically connected through the dielectric substrate 15.

Other variations are possible as illustrated in FIG. 5 wherein a base conductor 16 may be formed by deposition in a dielectric substrate 15 material and the top conductor 18 may be formed as previously disclosed. The dielectric substrate 15 material in each case may be flexible to rigid and be fiberglass, silicone and other suitable non-conductive material. In the instance of the use of a base conductor 16 in a dielectric substrate 15, the base conductor 16 may penetrate to the bottom surface of the dielectric substrate 15 or be contained within the dielectric substrate 15.

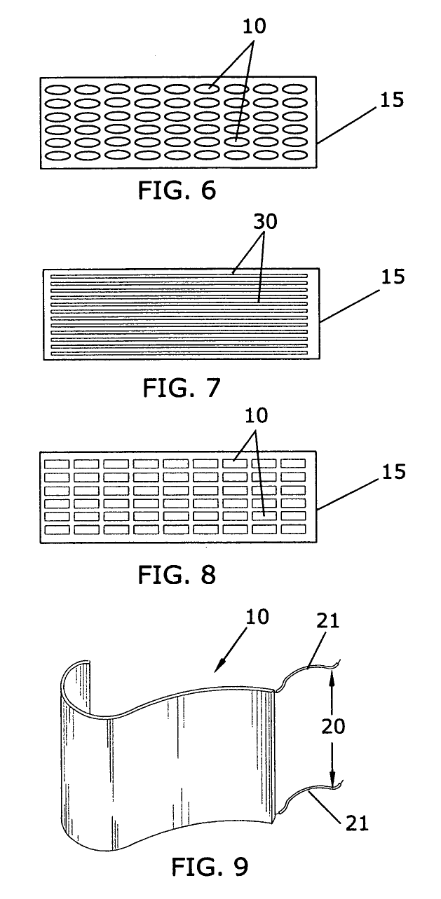

Referring to FIGS. 6 through 8, the microstructure visible light source 10 units may be fabricated in array structures by for example forming channels 30 in a dielectric or metal substrate 15 and disposing the microstructure visible light source 10 units in the channels 30. The geometry of an array may be used to control impedance matching.

The channels 30 may have a dimension of approximately 20 microns that may be the diameter of a spherical microstructure element 12 or dimensions of approximately 2 to 200 mils. The vertical and horizontal dimensions may be different. The shape of a channel may be arbitrary; rectangular is for illustrative purposes only. The channels 30 may also be formed in any desired pattern. The dielectric substrate 15 may be formed with metallic material having dielectric regions for microstructure visible light sources 10 and having positive and neutral electrical conduits for each array channel 30.

Arrays of microstructure visible light sources 10 may be formed in a pattern that may allow electronic addressing of individual portions of the array by the control of base conductors. This may allow specific areas of an array to be turned on and off or changed in intensity to produce a desired effect. The portions that may be controlled may be of arbitrary size, number and shape. The resolution may be as small as the size of a single microstructure. Such arrays may be constructed for control by a computer as the output display device or similar to plasma television displays.

For example, individual areas or pixels of the microstructures may be formed to emit the red, blue or green portion of the spectrum. The pixels may be of arbitrary dimension, shape and number. The generation of color may be accomplished by using different gases or combinations of gases in the microstructure elements, by control of the size or shape of the microstructure elements and by control of the electrical field characteristics that may be exciting the microstructure elements. Materials such as Phosphorous may be coated on the individual microstructures or integrated into the dielectric substrate to create desired color effects. The colors may not need to be pure red, blue and green, but may be designed to optimize fabrication costs, efficiencies or image reproduction capability.

Configurations of microstructure visible light sources may be used for replacement of fluorescent, filament, Halogen and the like light bulbs. Lighting structures may be fabricated that may be very thin, reference FIG. 9, for example, as wallpaper or as thick as desired. The lighting structure may be applied to walls, ceilings, floors, on land vehicles, into display units such as lamps, furniture and artwork. Displays such as billboards, signs and the like may also include visual light structures. The small size and other characteristics of the microstructure visible light source may also be useful in chemical detection, UV light generation, photodynamic therapy, gas chromatography and other emitted light applications. Microstructure visible light sources may be formed that may be rigid or flexible and of arbitrary shape and thickness.

While the invention has been particularly shown and described with respect to the illustrated embodiments thereof, it will be understood by those skilled in the art that the foregoing and other changes in form and details may be made therein without departing from the spirit and scope of the invention.

We claim:

1. A device to emit visible light comprising:
A microstructure element filled with a gas and disposed in a light transparent dielectric binder disposed between two spaced apart electrical conductors:
an electrical source in electrical communication with said electrical conductors wherein said electrical source transmits a signal to said electrical conductors to excite said gas to cause an electron in a plurality of gas molecules to transition to a higher energy state; and
said higher energy state is metastable and said higher energy state decays with emission of a photon at a selected wavelength.

2. The device as in claim 1 wherein said microstructure element is a glass container.

3. The device as in claim 1 wherein said microstructure structure is a microsphere of approximately 20 to 100 microns in diameter.

4. The device as in claim 1 wherein said gas is nitrogen.

5. The device as in claim 1 wherein said gas is a mixture of gases.

6. The device as in claim 1 wherein said microstructure element is coated with photo luminescent material.

7. The device as in claim 1 wherein said microstructure element is cylindrical in shape.

8. The device as in claim 1 wherein said microstructure element is an irregular shape.

9. The device as in claim 1 wherein a plurality of microsphere elements are disposed in an orderly pattern in said dielectric binder.

10. The device as in claim 1 wherein said dielectric binder has a relatively high dielectric breakdown strength.

11. The device as in claim 1 wherein said dielectric binder has a phosphorus material disposed therein.

12. The device as in claim 1 wherein one of said conductors is a base conductor.

13. The device as in claim 12 wherein said base conductor is formed of a metal coated with kapton.

14. The device as in claim 12 wherein said base conductor is approximately between 1 mil and 10 mils thick.

15. The device as in claim 1 wherein one of said conductors is a top conductor and is transparent to light.

16. The device as in claim 15 wherein said top conductor is formed of a substrate material and has an electrically conductive coating.

17. The device as in claim 15 wherein said top conductor is formed of a suitable transparent material and is coated with a thin electrically conductive material.

18. The device as in claim 17 wherein said thin electrically conductive material is indium tin oxide.

19. The device as in claim 1 wherein said device is structured to channel emitted light to exit at a top of a microstructure visible light source.

20. The device as in claim 1 wherein a plurality of said microstructure elements are disposed in a dielectric substrate material.

21. The device as in claim 20 wherein said dielectric substrate material has a plurality of channels therein with said dielectric binder and said microstructure elements disposed therein.

22. The device as in claim 21 wherein one of each of said electrical conductors is disposed at one of a first side and a second side of said dielectric binder.

23. The device as in claim 20 wherein one of said electrical conductors is a base conductor formed by deposition in a dielectric substrate.

24. The device as in claim 20 wherein the geometry of a plurality of microstructure visible light source units is structured in an array to control impedance matching.

25. The device as in claim 21 wherein said channels have a cross-section dimension of approximately the circumference of a microstructure element.

26. The device as in claim 21 wherein said dielectric substrate material is formed with a metallic material having dielectric regions for a plurality of microstructure visible light sources and a positive and a neutral electrical conduit for each of said channels.

27. The device as in claim 20 wherein a pattern of emitted light of a plurality of microstructure visible light source units is controlled by selective activation of a base conductor of each of said microstructure visible light source units.

28. The device as in claim 27 wherein a plurality of said microstructure elements are formed to emit one of a red, a green and a blue light wavelength and an array of said red, said green and said blue microstructure elements are adjacently disposed.

29. A method for producing visible light wavelength emissions comprising:
disposing a microstructure element filled with a gas in a light transparent dielectric binder that is disposed between two spaced apart electrical conductors; and
controlling the strength and modulation of a power source connected to said electrical conductors to control said visible light wavelength emission.

30. The method as in claim 29 further comprising selecting a structure size and a wall composition for said microstructure element to produce selected visible light wavelength emissions.

31. The method as in claim 29 further comprising selecting said gas to produce selected visible light wavelength emissions.

32. The method as in claim 29 further comprising selecting a dielectric binder material to produce selected visible light wavelength emissions.

33. The method as in claim 29 further comprising selecting a geometry for each of said conductors to produce selected patterns of visible light wavelength emissions.

34. The method as in claim 29 further comprising controlling said power source voltage, pulse width and pulse repetition frequency to adjust a selected spectral content, efficiency and durability for said microstructure elements.

35. The method as in claim 29 further comprising forming an array of microstructure visible light sources wherein the geometry of said array is structured to control impendence matching.

36. The method as in claim 29 further comprising controlling impendence matching for producing visible light wavelength emissions by selection of microstructure element geometry, conductor spacing, conductor material and dielectric material.
